(19) United States
(12) Patent Application Publication
(10) Pub. No.: US 2010/0030836 A1
(43) Pub. Date: Feb. 4, 2010

(54) Adder, Synthesis Device Thereof, Synthesis Method, Synthesis Program, and Synthesis Program Storage Medium

(75) Inventor: Kouichi Nagano, Osaka (JP)

Correspondence Address: STEPTOE & JOHNSON LLP, 1330 CONNECTICUT AVE., NW, WASHINGTON, DC, 20036, US

(73) Assignee: Matsushita Electric Industrial Co., Ltd., Kadoma-shi (JP)

(21) Appl. No.: 11/884,278

(22) PCT Filed: Feb. 16, 2006
(86) PCT No.: PCT/JP2006/302720

§ 371 Date: Aug. 14, 2007

(30) Foreign Application Priority Data
Feb. 17, 2005 (JP) 2005-041372

(51) Int. Cl. G06F 7/501

(52) U.S. Cl. 708/670

(57) ABSTRACT

A conventional multi-input adder has a problem that only either the number of stages of operation blocks or the number of half adders and full adders can be reduced.

In order to solve the problem of the prior art, half adders (HA201, HA203, HA204, HA202, HA205) are used only in a position at a lower digit having two inputs in an operation block (2a), a position having five inputs and two carries from the lower digit in a stage three stages prior to a final-stage operation block (2d), and a position one stage prior to the final-stage operation block (2d).

### TECHNICAL FIELD

The present invention relates to an arithmetic circuit for binary digits, and more particularly, to an improved multi-input adder which receives plural binary digits and adds the binary digits.

Further, the present invention relates to a synthesis device for automatically synthesizing the improved multi-input adder, a synthesis method, a synthesis program, and a synthesis program storage medium.

### BACKGROUND ART

A multi-input adder which performs addition of plural input data is indispensable as a fundamental arithmetic circuit for digital signal processing. Further, there are cases where a fundamental arithmetic circuit such as an adder determines the performance of the whole system, and therefore, a small-sized and high-speed multi-input adder has been demanded.

Up to now, various patent applications for constructions of adders have been filed (for example, refer to Patent Document 1, Patent Document 2, and Patent Document 3).

FIG. 5 shows a conventional example of a multi-input adder. In FIG. 5, a multi-input adder 1 has operation blocks 2a, 2b, 2c, . . . , 2n. The operation block 2a receives multiple bits of data from input 1 to input N (N is an integer equal to or larger than 2), the respective operation blocks 2a, 2b, 2c, . . . , 2n perform additions, and the operation block 2n outputs plural bits of data from output 1 to output N which are output bits. In the multi-input adder, plural data are treated for each bit.

For example, the inputted data of the plural binary digits correspond to partial products that are calculated when a multiplication result is obtained in a multiplier.

FIG. 6 shows an example of partial products calculated by a multiplier. In this example, partial products of multiplication obtained when each of two inputs comprises 6 bits are shown. As shown in FIG. 6(a), partial products aᵢbⱼ are calculated at the respective digits (bits) aᵢ,bⱼ of a multiplicand a and a multiplier b, like multiplication by writing. However, aᵢ,bⱼ=0 or 1, and i, j=1˜6. FIG. 6(b) is obtained by transforming FIG. 6(a) to a form that is easy to understand, with weights on the respective bits being the same as those in FIG. 6(a).

In order to obtain a multiplication result by adding the partial products shown in FIG. 6, usually, a half adder or a full adder is used. FIG. 7 shows inputs and outputs to/from a half adder and a full adder. FIG. 7(a) shows a half adder, and FIG. 7(b) shows a full adder.

The half adder shown in FIG. 7(a) has two inputs. That is, a one-digit binary number (bit) is input to each of input 1 and input 2, and a sum of the inputs and a one-digit binary number as a carry are outputted. The full adder shown in FIG. 7 has three inputs. That is, two one-digit binary numbers and a one-digit carry from the lower digit are input to input 1, input 2, and input 3, respectively, and a sum of these inputs and a one-digit binary number as a carry are outputted.

FIG. 8 shows an example of an arithmetic operation using the half adder and the full adder shown in FIG. 7 when performing additions of the partial products outputted from the multiplier shown in FIG. 6. FIG. 8 shows two examples of 8(a) and 8(b). FIGS. 8(a) and 8(b) show inputs for the respective bits in the respective operation blocks, and positions where the adders can be applied. Further, these figures show how the additions successively proceed according to the flow of time from the upper stage to the lower stage of the operation blocks.

In the example of FIG. 8(a), the half adder and the full adder are allocated to the digits having two bits or more in the respective stages of the operation blocks 2a to 2d, and to all the digits for which the half adder and the full adder can be used.

To be specific, when a digit having a certain weight comprises 1 bit, neither the half adder nor the full adder is allocated (MSB and LSB),

when it comprises 2 bits, a half adder is allocated (HA1 at the 2nd bit or HA4 at the 10th bit),

when it comprises 3 bits, a full adder is allocated (FA1 at the 3rd bit or FA8 at the 9th bit),

when it comprises 4 bits, a full adder is allocated to 3 bits (FA2 at the 4th bit or FA7 at the 8th bit),

when it comprises 5 bits, a full adder and a half adder are allocated (FA3 and HA2 at the 5th bit or FA6 and HA3 at the 7th bit), and

when it comprises 6 bits, two full adders are allocated (FA4 and FA5 at the 6th bit).

In this example, four stages of operation blocks are required.

In FIG. 8(a), half adders HA1˜HA4 and full adders FA1˜FA8 are allocated to the first-stage operation block (2a), half adders HA5˜HA8 and full adders FA9˜FA13 are allocated to the second-stage operation block (2b), and half adders HA9˜HA13 and full adders FA14˜FA16 are allocated to the third-stage operation block (2c).

In the example of FIG. 8(b), full adders are allocated to all the places where the full adders can be used, and a half adder is allocated to only the least significant bit side where the half adder can be used, viewed from the least significant bit. In this example, six stages of operation blocks 2a to 2f are required.

In FIG. 8(b), a half adder HA101 and full adders FA101˜FA108 are allocated to the first-stage operation block (2a), a half adder HA102 and full adders FA109˜FA114 are allocated to the second-stage operation block (2b), a half adder HA103 and full adders FA115˜FA117 are allocated to the third-stage operation block (2c), a half adder HA104 and full adders FA118˜FA119 are allocated to the fourth-stage operation block (2d), and a half adder HA105 and a full adder FA120 are allocated to the fifth-stage operation block (2e).

In the construction of FIG. 8(b), while the number of stages of the operation blocks is larger than that in the construction shown in FIG. 8(a), the total number of the half adders and the full adders is 25, which is less than 29 in FIG. 8(a). The number of stages of the operation blocks reflects the delay time, and the number of the half adders and the full adders constituting the operation blocks reflects the circuit scale. Although the circuit scale of the full adders becomes larger than that of the half adders, it is less than 1.5 times.

As described above, in the circuit construction shown in FIG. 8(a), since the full adders and the half adders are used in all the places where these adders can be used, the number of stages of the operation blocks is minimized and therefore this construction is suited for high-speed operation, but the circuit scale is undesirably increased.

On the other hand, in the circuit construction shown in FIG. 8(b), the half adder is used for the first bit where the half adder can be used, viewed from the least significant bit, and therefore, the number of input bits with carries is smaller and thereby the circuit scale is reduced, but the number of stages of the operation blocks is undesirably increased. Accordingly, while the circuit construction shown in FIG. 8(b) is suited for a circuit that requires miniaturization, it is not suited for high-speed operation.

Hereinafter, a description will be given of the manner of constituting the second-stage operation block with reference to FIGS. 9 and 10. FIGS. 9 and 10 show, for simplification, the result of addition performed by the first-stage operation block shown in FIG. 8(a), and the manner of constituting the second stage on the basis of the addition result. The stages subsequent to the second stage shown in FIG. 8(a) and the stages subsequent to the second stage shown in FIG. 8(b) can be constituted in similar procedures.

In FIGS. 9 and 10, since the least significant bit of the first-stage operation block is 1 bit and no target for addition exists, it becomes, as it is, the least significant bit of the second-stage operation block. A sum obtained by the half adder HA1 at the second bit of the first-stage operation block is assigned to the second bit of the second-stage operation block. A carry obtained by the half adder HA1 is assigned to the third bit of the second-stage operation block. A sum obtained by the full adder FA1 at the third bit of the first-stage operation block is also assigned to the third bit of the second-stage operation block. Accordingly, the third bit of the second-stage operation block comprises 2 bits, and a half adder can be allocated thereto. Thereafter, by successively repeating similar operations, the second-stage operation block and the subsequent stages can be constituted.

In this specification, it is called as “constitution” to determine inputs to the next-stage operation block as shown in the center of FIG. 9, and it is called as “construction” to allocate adders to the operation block for which the inputs are determined as shown in the lower part of FIG. 9. That is, in the stage where “constitution” has been completed, only the input/output relationship between the previous-stage operation block and the noticed-stage operation block is determined. On the other hand, in the stage where “construction” has been completed, since adders are allocated to the noticed stage, an actually operable operation block is obtained.

FIG. 10 shows a principle constitution of hardware that is required for realizing the stage where the second-stage operation block shown in FIG. 9 is constituted. In FIG. 10, the least significant bit of the first-stage operation block has a register R111. The second bit has registers R121 and R122, and a half adder HA1 for adding one bit of data which is temporarily stored in these registers. The third bit has registers R131, R132, and R133, and a full adder FA1 for adding one bit of data which is temporarily stored in these registers.

Further, the least significant bit of the second-stage operation block has a register R211 which stores one bit that is outputted from the register R111 of the first-stage operation block. The second bit of the second-stage operation block has a register R221 which stores a sum outputted from the half adder HA1 of the first-stage operation block. The third bit of the second-stage operation block has a register R231 which stores a carry outputted from the half adder HA1 of the first-stage operation block, and a register R232 which stores a sum outputted from the full adder FA1 of the first-stage operation block. The constitutions of the bits higher than the third bit will be omitted in description.

By the way, in the fourth-stage operation block (2d) shown in FIG. 8(a) and the sixth-stage operation block (2f) shown in FIG. 8(b), the input bits at all the digits are only two bits at most. In this specification, a stage where the inputs at all the digits in an operation block are only two bits at most is called a “final stage”.

When this final stage is constituted such that addition is carried out inside the final stage by using a CLA (Carry Look Ahead) method, a final sum of the multi-input adder can be obtained.

FIG. 11 shows the case where addition of the outputs from the fourth-stage operation block (=final stage) shown in FIG. 8(a) is carried out by the CLA method.

As shown in FIG. 11, since there is no addend at the respective bits from the least significant bit to the fourth bit, the respective bits are, as they are, assigned as the bits from the least significant bit to the fourth bit of the addition result. Since an augend and an addend exist at the fifth bit, a sum of them is assigned as the fifth bit of the addition result. Further, a carry at the fifth bit is assigned as one of addends at the sixth bit. At the sixth bit, original augend and addend are added to the carry from the fifth bit, and a sum of them is assigned as the sixth bit of the addition result. Further, a carry at the sixth bit is assigned as one of addends at the seventh bit.

Thereafter, similar processing is repeated, and a sum obtained at the twelfth bit is assigned as an addition result at the twelfth bit, and a carry thereof is assigned as a most significant bit of the addition result to the heads of the addition results from the twelfth bit to the least significant bit, thereby obtaining a final addition result.

Patent Document 1: Japanese Published Patent Application No. Hei.5-6262 (Page 2, FIG. 1)

Patent Document 2: Japanese Published Patent Application No. Hei.5-233226 (Pages 2-3, FIG. 1)

Patent Document 3: Japanese Published Patent Application No. Hei.6-348457 (Pages 5-7, FIG. 1)

### DISCLOSURE OF THE INVENTION

### Problems to be Solved by the Invention

By the way, in the conventional multi-input adder, it is not easy to realize miniaturization and speeding-up of the circuit simultaneously, and as shown in FIGS. 8(a) and 8(b), only either the number of stages of the operation blocks or the number of the half adders and the full adders can be reduced.

The present invention is made to solve the problems in the above-mentioned prior arts and has for its object to provide a multi-input adder which can simultaneously achieve miniaturization and speeding-up of the circuit, and can simultaneously reduce the number of stages of operation blocks and the number of half adders and full adders, and furthermore, a synthesis device for such multi-input adder, a synthesis method, a synthesis program, and a synthesis program storage medium.

### Measures to Solve the Problems

An adder according to claim 1 of the present invention is an adder having plural stages of operation blocks, each operation block including at least either of half adders and full adders and having inputs of plural digits, wherein, in an operation block which is three stages prior to a final-stage operation block, a half adder is provided at a digit which is located by one digit upper than a digit having two carries of a full adder, and has five inputs.

According to the adder relating to claim 1 of the present invention, the number of inputs to the particular bits of the operation block that is two stages prior to the final stage, eventually, the number of stages of the operation blocks, are reduced, thereby providing a multi-input adder that can achieve simultaneous pursuit of circuit scale reduction and speed-up.

Further, according to claim 2 of the present invention, in the adder defined in claim 1, the inputs of plural digits are signed integers or signed decimals.

According to the adder relating to claim 2 of the present invention, it is possible to obtain a multi-input adder that can achieve simultaneous pursuit of circuit scale reduction and speed-up even when the adder receives signed integers or signed decimals.

Further, according to claim 3 of the present invention, in the adder defined in claim 1, the inputs of plural digits are outputs from a partial product operation circuit which calculates partial products of inputs of multipliers.

According to the adder relating to claim 3 of the present invention, it is possible to obtain a multi-input adder that can achieve simultaneous pursuit of circuit scale reduction and speed-up even when the adder receives partial products.

Further, according to claim 4 of the present invention, in the adder defined in claim 3, the inputs of the multipliers are signed integers or signed decimals.

According to the adder relating to claim 4 of the present invention, it is possible to obtain a multi-input adder that can achieve simultaneous pursuit of circuit scale reduction and speed-up even when the adder receives partial products of signed integers or signed decimals.

Further, according to claim 5 of the present invention, in the adder defined in claim 1, the inputs of plural digits are outputs of a partial product operation circuit which calculates partial products of multipliers disposed in an input stage of an FIR (Finite Impulse Response) filter.

According to the adder relating to claim 5 of the present invention, it is possible to obtain a multi-input adder that can achieve simultaneous pursuit of circuit scale reduction and speed-up even when the adder receives partial products from the respective multipliers in an input stage of an FIR filter.

Further, according to claim 6 of the present invention, in the adder defined in claim 5, the inputs of the FIR filter are signed integers or signed decimals.

According to the adder relating to claim 6 of the present invention, it is possible to obtain a multi-input adder that can achieve simultaneous pursuit of circuit scale reduction and speed-up even when the adder receives signed integers or signed decimals as partial products from the respective multipliers in an input stage of an FIR filter.

Further, according to claim 7 of the present invention, in the adder defined in claim 5, the FIR filter has signed integers or signed decimals as factors.

According to the adder relating to claim 7 of the present invention, it is possible to obtain a multi-input adder that can achieve simultaneous pursuit of circuit scale reduction and speed-up even when the adder receives signed integers or signed decimals as partial products from the respective multipliers in an input stage of an FIR filter.

Further, according to claim 8 of the present invention, in the adder defined in claim 1, in each stage of the operation block, a half adder is provided at a digit which is positioned at the least significant side and has inputs the number of which is not one, and has two inputs.

According to the adder relating to claim 8 of the present invention, the number of inputs to the particular bits in the next-stage operation block, eventually, the number of stages of the operation blocks are reduced, thereby providing a multi-input adder that can achieve simultaneous pursuit of circuit scale reduction and speed-up.

Further, according to claim 9 of the present invention, in the adder defined in claim 8, a half adder is provided in an operation block which is one stage prior to a final-stage operation block.

According to the adder relating to claim 9 of the present invention, the number of inputs to the particular bits in a final-stage operation block, eventually, the number of stages of the operation blocks are reduced, thereby providing a multi-input adder that can achieve simultaneous pursuit of circuit scale reduction and speed-up.

Further, according to claim 10 of the present invention, in the adder defined in claim 9, in an operation block which is one stage prior to a final-stage operation block, a half adder is provided at a digit which is lower than a digit that is positioned at the most significant side and has inputs the number of which is one.

According to the adder relating to claim 10 of the present invention, since a half adder is provided at a bit that is lower than the most significant bit where the number of inputs is one, the number of inputs to the particular bits in the final-stage operation block, eventually, the number of stages of the operation blocks can be reduced, thereby providing a multi-input adder that can achieve simultaneous pursuit of circuit scale reduction and speed-up.

Further, according to claim 11 of the present invention, there is provided a synthesis device for an adder having plural stages of operation blocks, each operation block including at least either of half adders and full adders and having inputs of plural digits, wherein, in an operation block which is three stages prior to a final-stage operation block, a half adder is allocated to a digit which is located by one digit upper than a digit having two carries of a full adder, and has five inputs.

According to the adder synthesis device relating to claim 11 of the present invention, a synthesis device for automatically synthesizing a multi-input adder which can reduce the number of inputs to the particular bits of the operation block two stages prior to the final stage, eventually, the number of stages of the operation blocks, thereby achieving simultaneous pursuit of circuit scale reduction and speed-up, can be obtained.

Further, according to claim 12 of the present invention, in the adder synthesis device defined in claim 11, in each stage of the operation block, a half adder is allocated to a digit which is positioned at the least significant side and has inputs the number of which is not one, and has two inputs.

According to the adder synthesis device relating to claim 12 of the present invention, a synthesis device for automatically synthesizing a multi-input adder which can reduce the number of inputs to the particular bits of the next-stage operation block, eventually, the number of stages of the operation blocks, thereby achieving simultaneous pursuit of circuit scale reduction and speed-up, can be obtained.

Further, according to claim 13 of the present invention, in the adder synthesis device defined in Claim 12, a half adder is allocated to an operation block which is one stage prior to a final-stage operation block.

According to the adder synthesis device relating to claim 13 of the present invention, a synthesis device for automatically synthesizing a multi-input adder which can reduce the number of inputs to the particular bits of the final-stage operation block, eventually, the number of stages of the operation blocks, thereby achieving simultaneous pursuit of circuit scale reduction and speed-up, can be obtained.

Further, according to claim 14 of the present invention, in the adder synthesis device defined in claim 13, in an operation block that is one stage prior to a final-stage operation block, a half adder is allocated to a digit which is lower than a digit that is positioned on the most significant side and has inputs the number of which is one.

According to the adder synthesis device relating to claim 14 of the present invention, a synthesis device for automatically synthesizing a multi-input adder which reduces the number of inputs to the particular bits of the final-stage operation block, eventually, the number of stages of the operation blocks, thereby achieving simultaneous pursuit of circuit scale reduction and speed-up, can be obtained.

Further, according to claim 15 of the present invention, there is provided a synthesis method for an adder having plural stages of operation blocks, each operation block including at least either of half adders and full adders and having inputs of plural digits, and the method includes a process of allocating a half adder to a digit which is located by one digit higher than a digit having two carries of a full adder, and have five inputs, in an operation block which is three stages prior to a final-stage operation block.

According to the adder synthesis method relating to claim 15 of the present invention, a synthesis method for automatically synthesizing a multi-input adder which can reduce the number of inputs to the particular bits in the operation block two stages prior to the final stage, eventually, the number of stages of the operation blocks, thereby achieving simultaneous pursuit of circuit scale reduction and speed-up, can be obtained.

Further, according to claim 16 of the present invention, there is provided an adder synthesis program which makes a computer perform the adder synthesis method defined in claim 15.

According to the adder synthesis program relating to claim 16 of the present invention, a synthesis program for automatically synthesizing a multi-input adder which can reduce the number of inputs to the particular bits in the operation block two stages prior to the final stage, eventually, the number of stages of the operation blocks, thereby achieving simultaneous pursuit of circuit scale reduction and speed-up, can be obtained.

Further, according to claim 17 of the present invention, there is provided an adder synthesis program storage medium in which the adder synthesis program defined in claim 16 is stored.

According to the adder synthesis program storage medium relating to claim 17 of the present invention, an adder synthesis program storage medium for automatically synthesizing a multi-input adder which can reduce the number of inputs to the particular bits of the operation block two stages prior to the final stage, eventually, the number of stages of the operation blocks, thereby achieving simultaneous pursuit of circuit scale reduction and speed-up, can be obtained.

### EFFECTS OF THE INVENTION

According to an adder of the present invention, since places where half adders are to be used are restricted when constituting a multi-input adder, a compact and high-speed multi-input adder can be realized.

Further, according to an adder synthesis device, synthesis program, and synthesis program recording medium of the present invention, since places where half adders are to be used are restricted when synthesizing a multi-input adder, it is possible to provide a synthesis device, a synthesis program, and a synthesis program recording medium which can synthesize a compact and high-speed multi-input adder.

### BRIEF DESCRIPTION OF THE DRAWINGS

FIG. 1 is a block diagram illustrating a structure of a multi-input adder according to a first embodiment of the present invention.

FIG. 2 is a diagram illustrating operation blocks of the multi-input adder according to the first embodiment of the present invention.

FIG. 3 is a diagram illustrating a structure of a multi-input adder according to the first and second embodiments of the present invention.

FIG. 4 is a circuit diagram illustrating a structure of an FIR filter.

FIG. 5 is a block diagram illustrating a structure of a conventional multi-input adder.

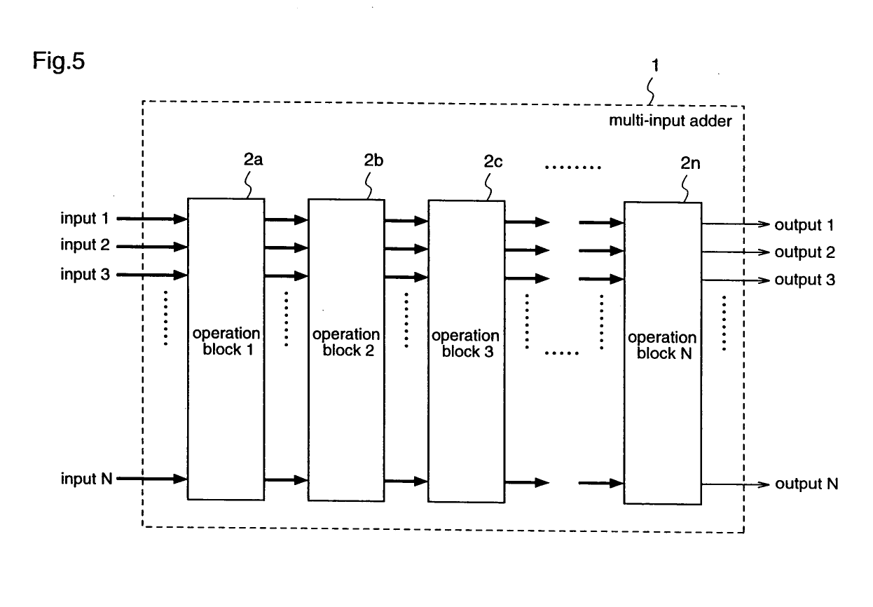

FIG. 6 is a schematic diagram illustrating a partial product operation to be performed by a multiplier.

FIG. 7 is a schematic diagram illustrating operations to be performed by a half adder and a full adder.

FIG. 8 is a diagram illustrating examples of operation blocks of a multiplier.

FIG. 9 is a diagram illustrating a method for constructing a first-stage operation block and a second-stage operation block.

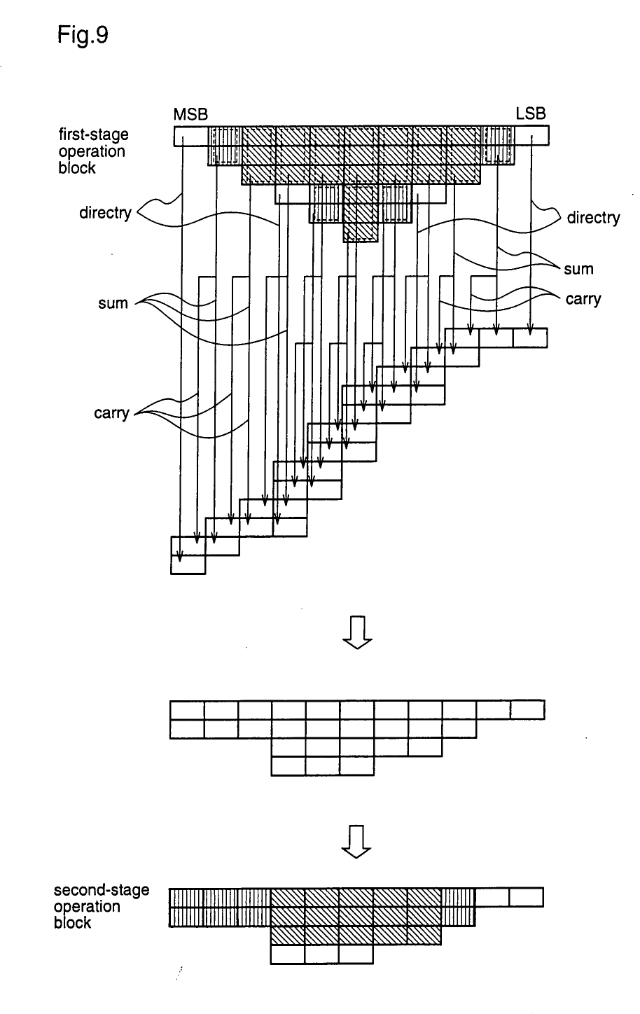

FIG. 10 is a diagram illustrating a structure of the second-stage operation block.

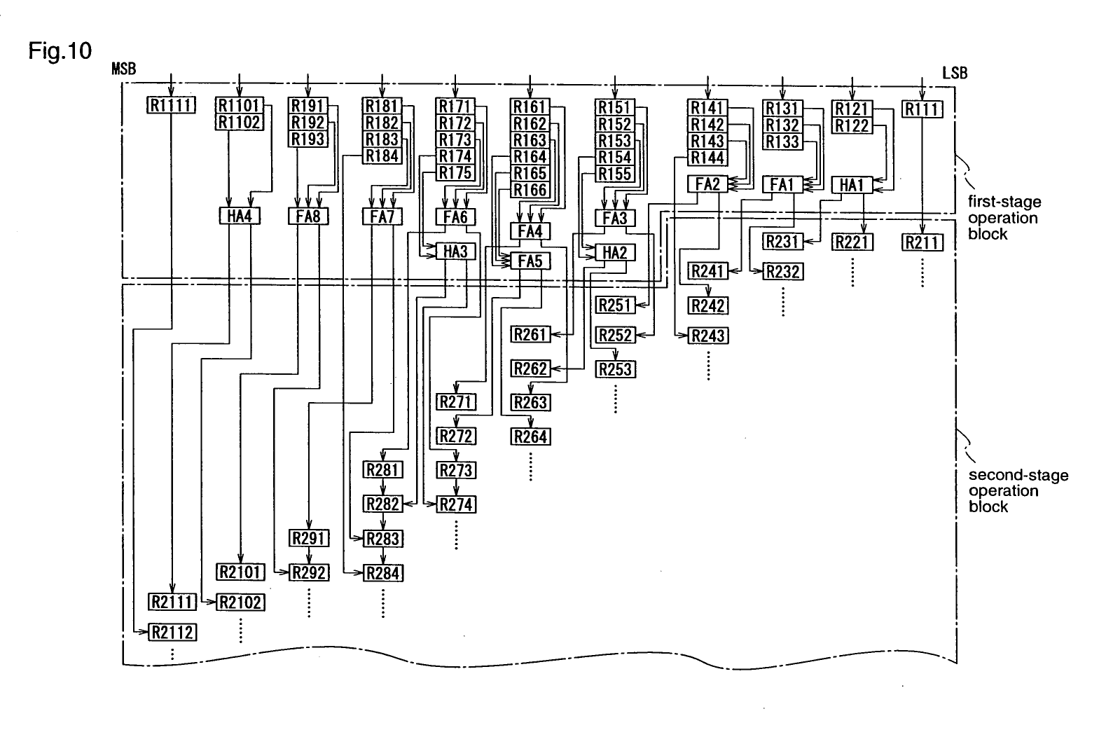

FIG. 11 is a diagram illustrating a method for allocating adders to the final-stage operation block by the CLA method.

FIG. 12 is a diagram illustrating a first pass of a process to be executed by an automatic circuit synthesis device for a multi-input adder.

FIG. 13 is a diagram illustrating a second pass of the process to be executed by the automatic circuit synthesis device for a multi-input adder.

FIG. 14 is a diagram illustrating an information processing device for executing a program in which an automatic circuit synthesis method is described.

FIG. 15 is a block diagram illustrating the automatic circuit synthesis device for a multi-input adder.

### DESCRIPTION OF REFERENCE NUMERALS

1 . . . multi-input adder
2a,2b,2c,˜2n . . . operation blocks
3,3a,3b,3c,3d . . . partial product operation circuits
4a,4b,4c,4d . . . multipliers
5a,5b,5c . . . adders
FA201,FA202,FA203,FA204,FA205,FA206,FA207,FA208,FA209,FA210, FA211,FA212,FA213,FA214,FA215,FA216,FA217,FA218,FA1,FA2,FA3,FA4,F A5,FA6,FA7,FA8,FA9,FA10,FA11,FA12,FA13,FA14,FA15,FA16,FA101,FA102, FA103,FA104,FA105,FA106,FA107,FA108,FA109,FA110,FA111,FA112,FA113, FA114,FA115,FA116,FA117,FA118,FA119,FA120 . . . full adders
HA201,HA202,HA203,HA204,HA205,HA1,HA2,HA3,HA4,HA5,HA6,HA7,HA 8,HA9,HA10,HA11,HA12,HA13,HA14,HA15,HA16,HA101,HA102,HA103,HA104, HA105 . . . half adders
100 . . . automatic circuit synthesis device
101 . . . control unit
102 . . . input unit
103 . . . partial product operation unit
104 . . . half adder allocatable position search unit
105 . . . full adder allocatable position search unit
106 . . . half adder allocation unit
107 . . . full adder allocation unit
108 . . . operation block corresponding stage construction unit
109 . . . operation block constitution unit
110 . . . operation block next stage construction unit
111 . . . judgment unit
112 . . . final stage construction unit
113 . . . output unit
201,202,203,204,205,206,207,208,209,210,211,212,213,214,215, 216,217,218,219,220,221,222,223,224,225,226 . . . steps

### BEST MODE TO EXECUTE THE INVENTION

Hereinafter, embodiments of the present invention will be described with reference to the drawings.

### Embodiment 1

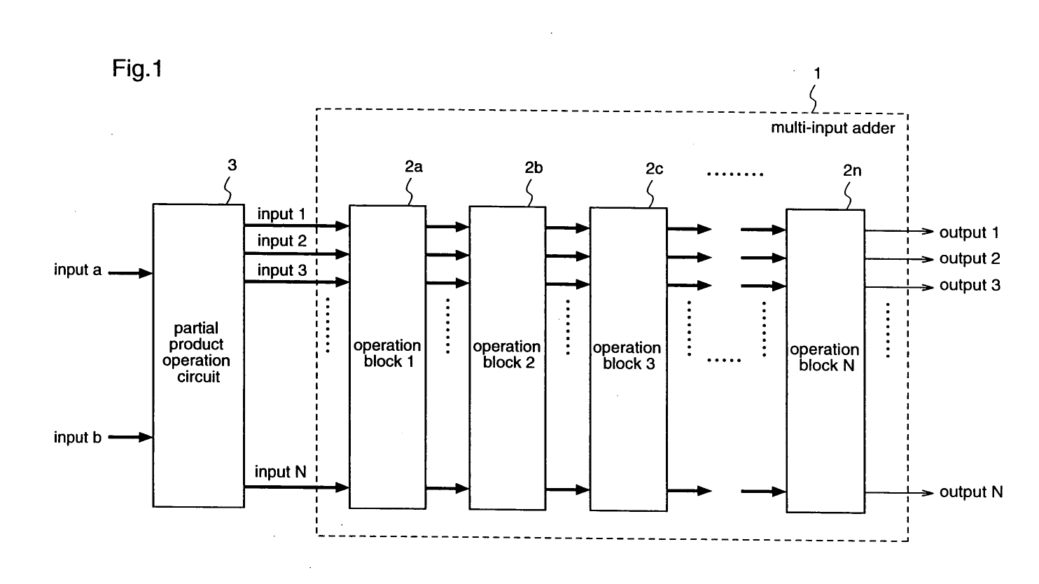

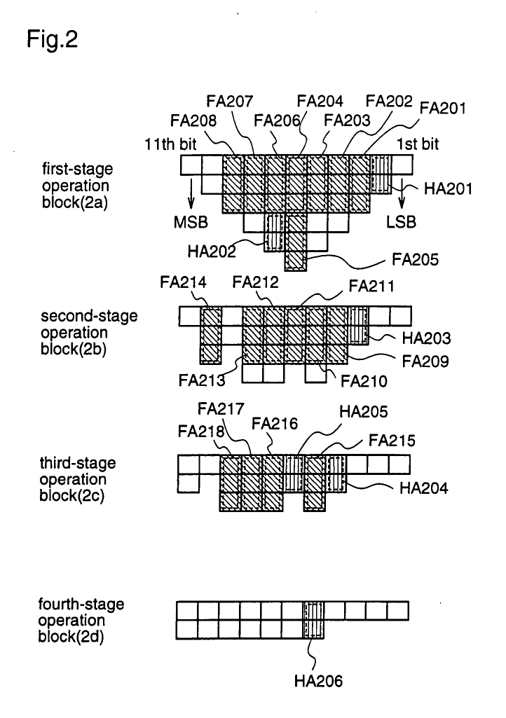

Initially, a multi-input adder according to a first embodiment of the present invention will be described with reference to FIGS. 1 and 2.

FIG. 1 is a block diagram illustrating a multi-input adder according to the first embodiment of the present invention. In FIG. 1, the multi-input adder 1 is constituted by cascade-connecting operation blocks 2a, 2b, 2c, . . . , 2n in this order. A partial product operation circuit 3 is disposed in front of the operation block 2a, and performs an operation for obtaining a partial product. The partial product operation circuit 3 and the multi-input adder 1 constitute a multiplier which performs multiplication of inputs a and b.

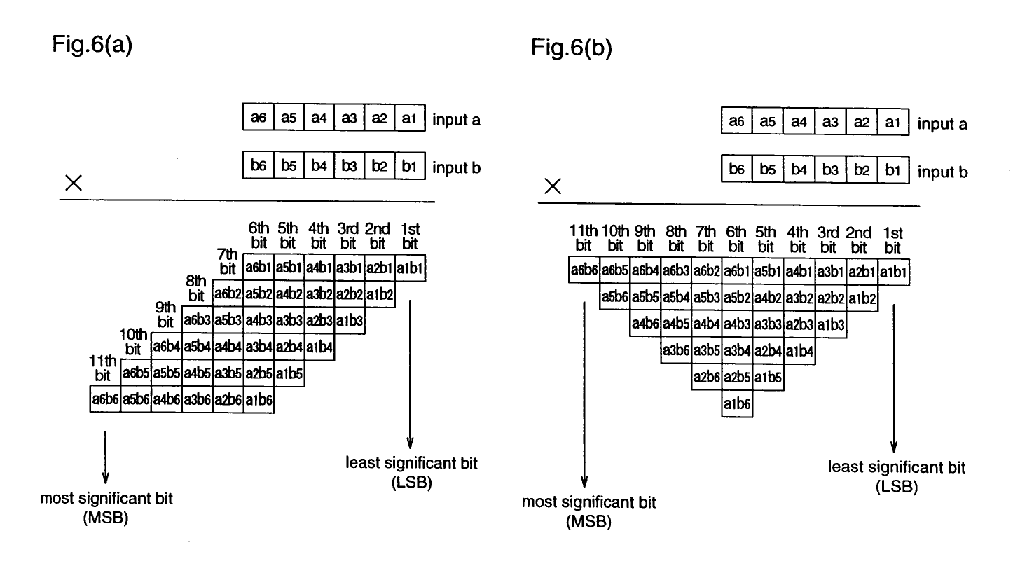

Next, the operation will be described. The partial product operation circuit 3 receives two pieces of multi-bit data a and b as shown in FIG. 6(a) or 6(b) and obtains partial products aᵢbᵢ, and the operation blocks 2a, . . . , 2n perform addition of inputs 1 to N (outputs of the partial product operation circuit 3) to output data of outputs 1 to N which are output bits. This addition is performed so that the partial products having the same bit weight are added, such as a₂b₁+a₁b₂ at the second bit or a₃b₁+a₂b₂+a₁b₃ at the third bit shown in FIG. 6(a) or 6(b).

Next, a description will be given of construction of operation blocks. FIG. 2 shows an example of constructing operation blocks of a 6-bit multi-input adder.

With reference to FIG. 2, half adders and full adders are used for additions of binary data in the respective operation blocks. The first-stage operation block (2a) has half adders HA201 and HA202, and full adders FA201 to FA208. Further, the second-stage operation block (2b) has a half adder HA203 and full adders FA209 to FA214. Further, the third-stage operation block (2c) has half adders HA204 and HA205 and full adders FA215 to FA218.

The half adders and the full adders are used under the following conditions.

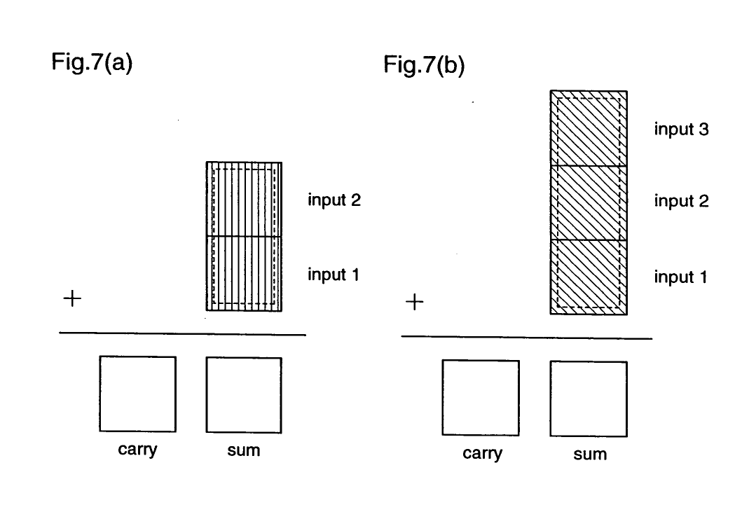

i) First of all, the full adders are used in all the positions where the full adders can be used. For example, in the first-stage operation block (2a) shown in FIG. 2, the full adders FA201 to FA208 are used at the bits from the third bit to the ninth bit where three or more bits of inputs exist. As shown in FIG. 7, each full adder receives three data and outputs two data. That is, it receives the original two bits of inputs and one bit of carry, and outputs one bit of addition output and one bit of carry-out. Accordingly, at the bit having each weight, every three data are input to the full adder.

ii) Next, a half adder is used only in a position of a bit on the least significant bit side, where the half adder can be used.

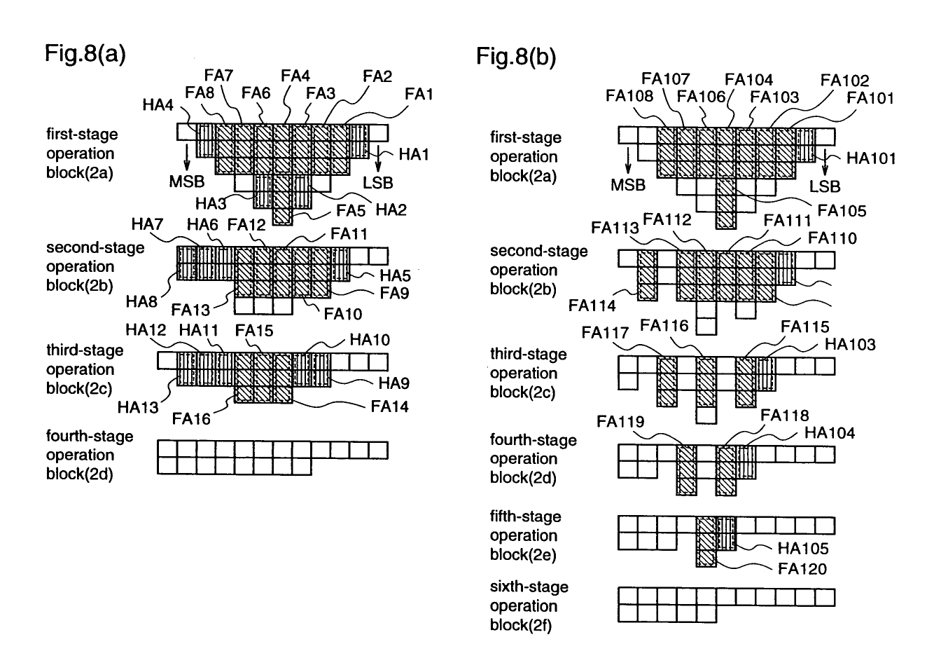

For example, in the first-stage operation block (2a) shown in FIG. 2, the half adder HA201 is used in a position of the second bit from the least significant bit. Up to here, the constitution method is identical to that shown in FIG. 8(b).

iii) Next,

a) In an operation block that is three stages prior to the final-stage operation block,

b) at a bit position where the number of input bits is five, and

c) where the number of carry data from the lower bit is two, the full adder is used and thereafter the half adder is used in the position where the half adder can be used.

For example, in the case of FIG. 2, the bit position is the seventh bit from the least significant bit LSB in the first-stage operation block (2a) that is three stages prior to the final-stage operation block (2d). In this bit position, the number of input data is five, and the number of carry data from the lower bit is two (since two full adders are used in the sixth bit position), and therefore, the half adder HA 202 is used in this position.

d) Further, in a stage that is one stage prior to the final-stage operation block, half adders are used in all positions where the half adders can be used.

e) However, in the case of d), no half adder is used at a digit where there is no carry from the lower bit.

In the case of FIG. 2, the third-stage operation block (2c) corresponds to d), and the half adder HA205 is used at the digit of the sixth bit from the least significant bit LSB. Further, no half adder is used at the digit of the eleventh bit. The reason is that the number of inputs is one at the digit of the tenth bit and therefore no carry occurs.

The reason why the half adder HA204 is used for the fourth bit in the third-stage operation block (2c) is based on the rule of ii) mentioned above.

As a result, in the case of FIG. 2, the number of full adders is eighteen, the number of half adders is five, and the number of stages of operation blocks is four.

When the constitutional example shown in FIG. 2 thus obtained is compared with the constitutional examples shown in FIGS. 8(a) and 8(b), it is found that, in the constitutional example shown in FIG. 2, the number of stages of operation blocks is equal to that of FIG. 8(a) and the number of half adders and full adders is smaller than that of FIG. 8(b). That is, it is found that the constitution shown in FIG. 2 can achieve simultaneous pursuit of miniaturization and speeding-up.

The reason is as follows. By allocating a half adder to a position having five inputs in the first-stage operation block (2a) shown in FIG. 8(b), the corresponding digit in the second-stage operation block (2b) can be made to have four bits or less. Further, by using a half adder also in a position having a carry from the lower bit in the third-stage operation block (2c) shown in FIG. 8(b), the corresponding digit in the fourth-stage operation block can be made to have two bits or less. Thereby, the number of stages of operation blocks is reduced, and the number of adders is reduced.

As described above, according to the first embodiment of the present invention, in the multi-input adder having plural stages of operation blocks, full adders are used in all positions in each operation block where the full adders can be used, and a half adder is used only in a position on the least significant bit side in each operation block, and furthermore, a half adder is used in a position which has five inputs and corresponds to a digit one digit higher than a digit having two carries of a full adder in an operation block that is three stages prior to the final operation block, and a half adder is used at a digit having a carry from the lower bit in an operation block that is one stage prior to the final operation block. Therefore, the number of stages of operation blocks is reduced and thereby the delay time can be reduced, and furthermore, the numbers of full adders and half adders constituting the circuit can be reduced, resulting in a multi-input adder which can achieve simultaneous pursuit of reduction in operation time and reduction in circuit scale.

While in the first embodiment a multi-input adder having six bits of inputs is described as an example, even when the number of input bits becomes larger than six bits, a small-sized and high-speed circuit can be realized by using the same rules as the above-mentioned conditions i) to iii) as the usage conditions of half adders and full adders. This effect increases with an increase in the number of input bits, and the circuit scale can be significantly reduced to, for example, ⅓ of the conventional circuit scale with an increase in the operation speed.

In this case, since the later-stage operation block has smaller number of input bits, the stage where the number of input bits becomes six and the subsequent stages may be constituted like the operation blocks (2a) to (2d) shown in FIG. 2.

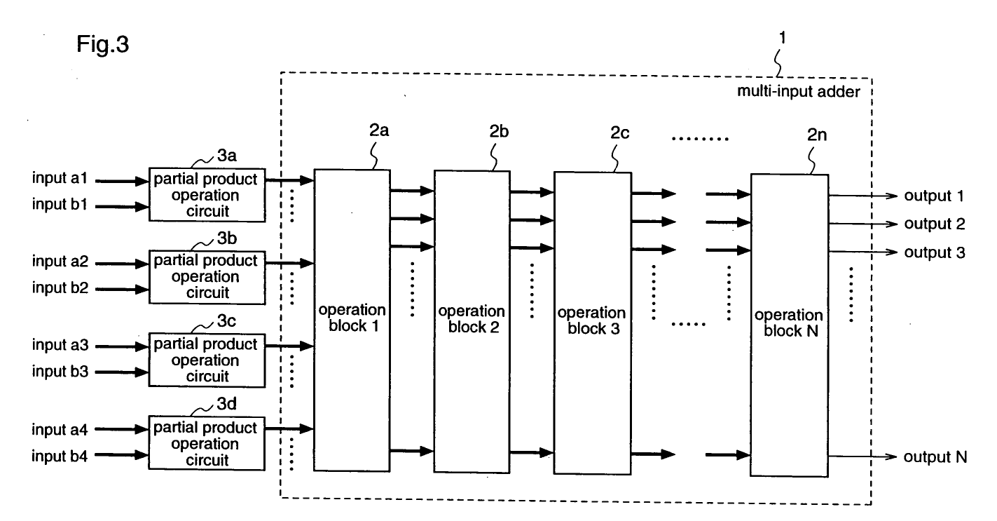

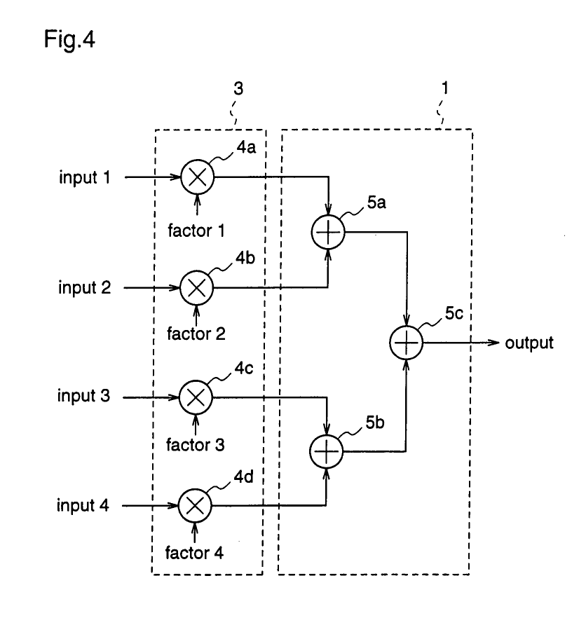

Further, the constitution of the multi-input adder according to the first embodiment of the present invention can be applied to multi-input adders in circuits shown in FIGS. 3 and 4.

FIG. 3 is a block diagram of a multi-input adder. In FIG. 3, reference numeral 1 denotes a multi-input adder, numerals 2a, 2b, 2c, . . . , 2n denote operation blocks, and 3a, 3b, 3c, and 3d denote partial product operation circuits.

The circuit shown in FIG. 3 is different from the circuit shown in FIG. 1 in that a plurality of partial product operation circuits exist. The plural partial product operation circuits respectively calculate partial products, and plural outputs corresponding to the respective bits are input to the multi-input adder. This constitution is effective in an arithmetic unit of a FIR filter or the like.

FIG. 4 is a constitutional example of an ordinary FIR filter. In FIG. 4, reference numerals 4a, 4b, 4c, and 4d denote multipliers, and numerals 5a, 5b, and 5c denote adders. The ordinary FIR filter is constituted as shown in FIG. 4, and each input and each factor are multiplied by each multiplier, and the outputs from the multiplier are successively added by each adder. Since each adder usually has two inputs, the number of stages of adders and the number of adders increase with an increase in the number of inputs to the FIR filter (the outputs from the multipliers). That is, the circuit scale of the FIR filter increases.

However, since a part 1 comprising the adders 5a, 5b, and 5c is a multi-input adder, when this multi-input adder is constituted in like manner as the multi-input adder shown in FIG. 2, the circuit scale thereof can be reduced. Accordingly, the circuit scale of the FIR filter can be reduced. Further, when each of the multipliers 4a, 4b, 4c, and 4d is constituted by a partial product operation circuit and a multi-input adder as shown in FIG. 3 (or FIG. 1) and the multi-input adder included in each multiplier is constituted in like manner as the multi-input adder shown in FIG. 2, the circuit scale thereof can be further reduced.

Furthermore, while in this first embodiment the inputs to the multi-input adder are positive binary numbers (integers), the inputs may be signed integers, decimals, or signed decimals.

### Embodiment 2

Hereinafter, a description will be given of an automatic circuit synthesis device for automatically synthesizing a multi-input adder which can realize simultaneous pursuit of reduction in circuit scale and increase in operating speed.

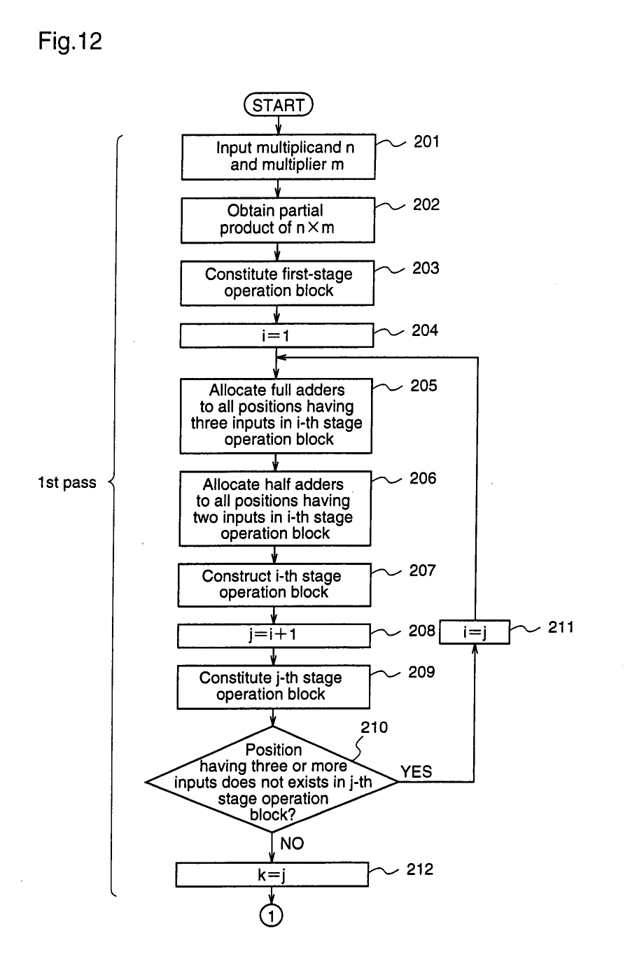

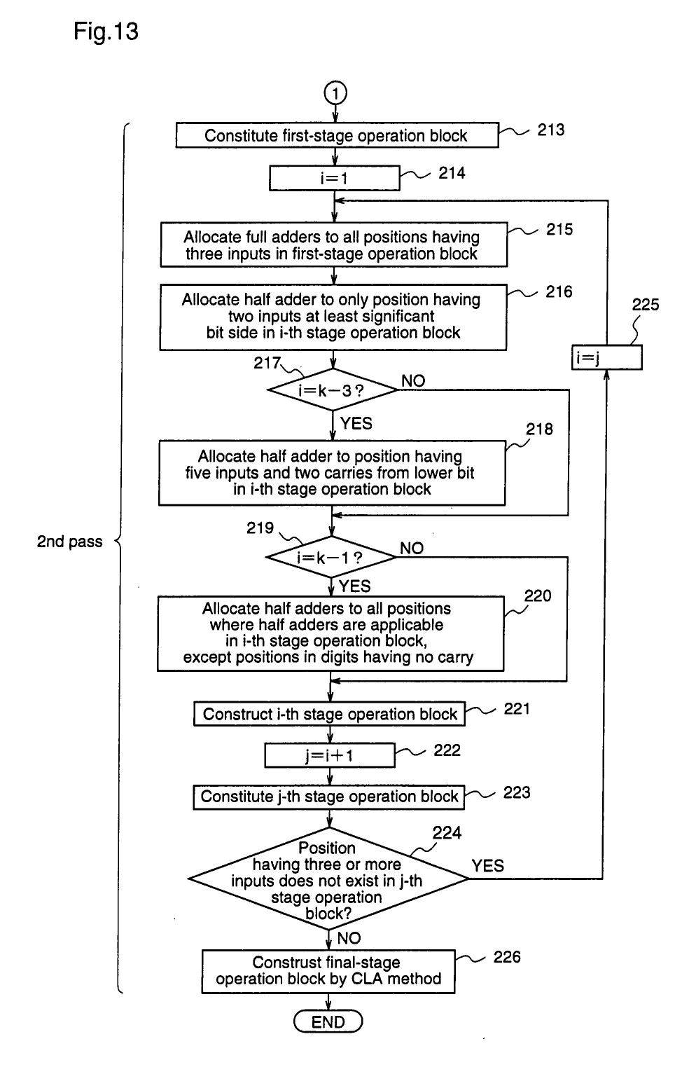

FIGS. 12 and 13 show a flow of processes to be executed by the automatic circuit synthesis device according to the second embodiment.

The flowcharts shown in FIGS. 12 and 13 synthesizes a multiplier having a multi-input adder which is reduced in circuit scale and performs high-speed operation, by a so-called two-pass method.

The reason why the two-pass method is adopted is as follows. That is, in the condition iii) described in the first embodiment, reduction in the number of operation stages is achieved by using the half adders also in positions other than the positions where the half adders are allocated in FIG. 8(b), in the third stage from the final stage and in the first stage from the final stage. However, when automatically synthesizing a multi-input adder, it is necessary to previously know what number stage the final stage is. The first pass is provided for this preprocessing. In this first pass, the same processings as those for constructing the first to fourth stages of operation blocks shown in FIG. 8(a) are carried out.

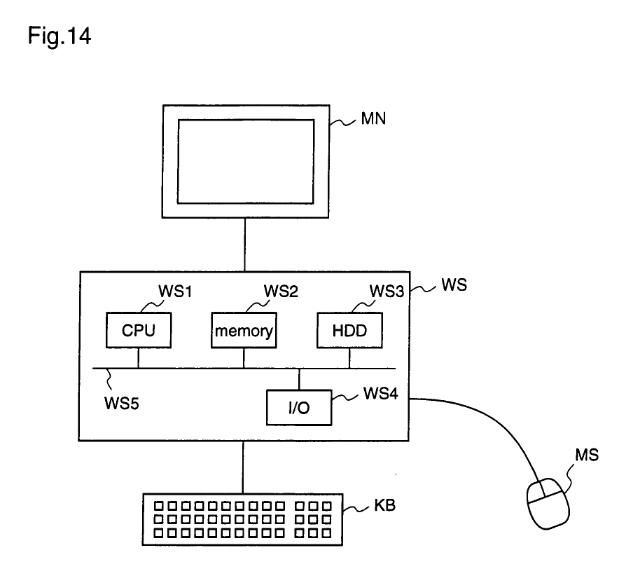

FIG. 14 shows an information processing device for executing a program in which an automatic circuit synthesis method that is similar to the method executed by the automatic circuit synthesis device is described. This information processing device may be a work station, a personal computer, a main frame, or the like.

In FIG. 14, a work station WS includes a CPU WS1, a memory WS2, an HDD WS3, an I/O WS4, and a bus WS5 which connects these units, and has, as peripheral devices, a monitor MN, a keyboard KB, and a mouse MS.

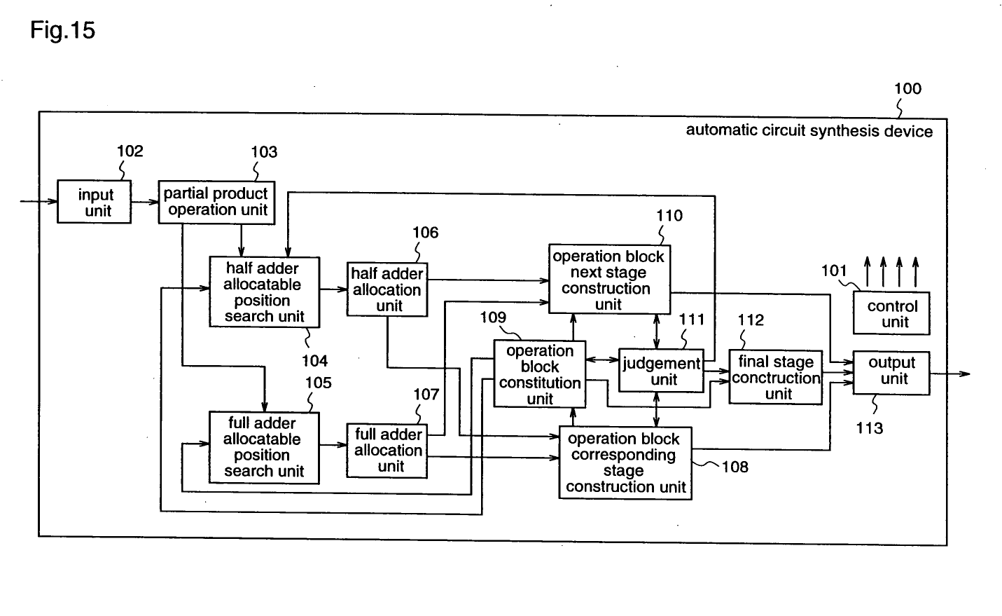

FIG. 15 is a block diagram illustrating the automatic circuit synthesis device which is implemented by the CPU WS1, the memory WS2, the HDD WS3, the I/O WS4, and the bus WS5 in the work station WS shown in FIG. 14.

In FIG. 15, the automatic circuit synthesis device 100 comprises a control unit 101, an input unit 102, a partial product operation unit 103, a half adder allocatable position search unit 104, a full adder allocatable position search unit 105, a half adder assignment unit 106, a full adder assignment unit 107, an operation block corresponding stage construction unit 108, an operation block constitution unit 109, an operation block next stage constitution unit 110, a judgment unit 111, a final stage construction unit 112, and an output unit 113.

Hereinafter, a flow of processes to be executed by the automatic circuit synthesis device will be described with reference to the flowcharts shown in FIGS. 12 and 13, and FIGS. 14 and 15.

Initially, the first pass is executed according to the flowchart shown in FIG. 12. In this first pass, a multiplicand n and a multiplier m (m, n: positive integers) of a multiplier to be automatically synthesized are input through the keyboard KB shown in FIG. 14 (refer to step 201). The input unit 102 captures the multiplicand n and the multiplier m of the multiplier into the automatic circuit synthesis device 100.

The partial product operation unit 103 calculates a partial product of n×m (refer to step 202), and collects partial products having the same bit weight for each digit as shown in FIG. 6(a), thereby constituting a state that is prior to allocation of full adders and half adders (refer to FIGS. 6(a) and 6(b)), which state will be a first-stage operation block (refer to step 203). Actually, this state is implemented as a data structure corresponding to FIG. 6(a) or 6(b).

As this data structure, a vector such as (i, j, k) may be used. Here, i indicates the i-th stage operation block, j indicates the j-th bit in the i-th stage operation block, and k indicates the number of inputs at the j-th bit in the i-th stage operation block.

Next, the control unit 101 sets i=1 (refer to step 204), and the full adder allocatable position search unit 105 and the half adder allocatable position search unit 104 search for positions where full adders and half adders can be allocated, from the data structure corresponding to the multi-input addition shown in FIG. 6(a) (or FIG. 6(b)). This search is carried out so that full adders and half adders are detected in all positions where these adders are available as shown in the first-stage operation block of FIG. 8(a) (refer to steps 205 and 206). Either of the steps 205 and 206 may be executed first, or these steps may be executed simultaneously. Next, the full adder assignment unit 107 and the half adder assignment unit 106 allocate the full adders and the half adders thus detected, and the operation block corresponding stage construction unit 108 constructs the first-stage operation block on the basis of this assignment (refer to step 207).

Next, the control unit 101 sets j=i+1(=2) (refer to step 208), and the operation block constitution unit 109 constitutes a state before allocation of full adders and half adders, which state will be the second-stage operation block (refer to step 209).

The judgment unit 111 judges whether or not a position having three or more inputs exists in the portion to be the second-stage operation block (refer to step 210). Since positions having three or more inputs exist in the portion to be the second-stage operation block, the control unit 101 sets i=j (refer to step 211) and returns the control to step 205, and then performs allocation of full adders and half adders to the portion to be the second stage in like manner as that for the first stage, thereby constructing the second stage.

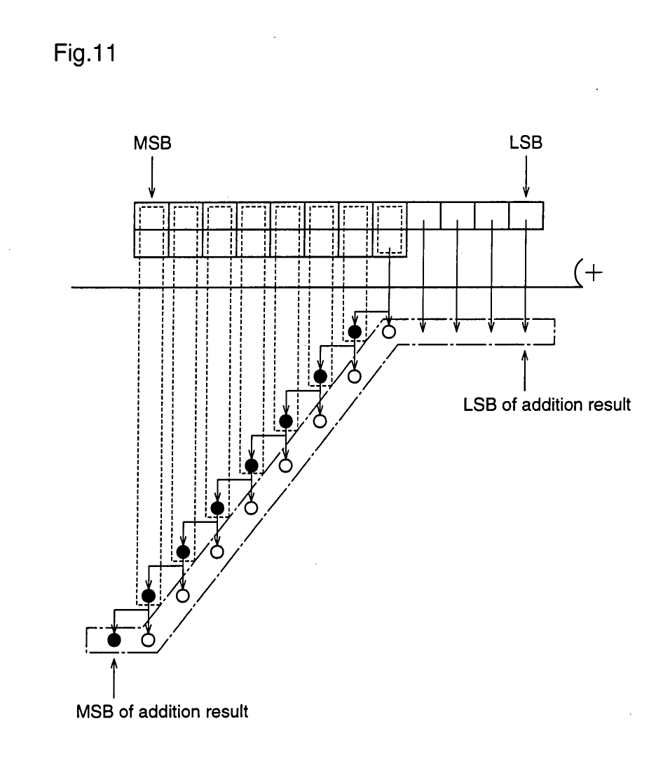

Thereafter, third and subsequent stages are constituted and constructed in like manner as mentioned above. When it is judged in step 210 that there exists no position having three or more inputs, the final stage construction unit 112 constructs the final-stage operation block as shown in FIG. 11 by the CLA method (refer to step 212). The control unit 101 stores the number of stages of operation blocks at this time as “k” (k: integer not less than 2) in a memory or the like (refer to step 212).

Thus, the first pass for judging what number stage the final stage of the multi-input adder corresponds to, has been completed. The respective stages of operation blocks that are constructed in this first pass are not used as actual automatic synthesis outputs.

Next, the second pass is executed according to the flowchart shown in FIG. 13. In this second pass, the original processing, i.e., the processing for actually constructing the respective stages of operation blocks which constitute the multi-input adder, is carried out.

In steps 213 to 215, the same processings as those performed in steps 203 to 205 are performed. Next, under control of the control unit 101, the half adder allocatable position search unit 104 allocates a half adder to only a position having two inputs on the least significant bit side in the first-stage operation block, in contrast to the first pass (refer to step 216).

Next, the judgment unit 111 judges whether i is equal to k−3 or not (refer to step 217). In the case of the first-stage operation block, since i is equal to k−3, the half adder allocatable position search unit 104 allocates a half adder to a position having five inputs and two carries from the lower bit, in the first-stage operation block (refer to step 218). When i is not equal to k−3, the control goes to step 219.

In step 219, the judgment unit 111 judges whether i is equal to k−1 or not. In the case of the first-stage operation block, since i is not equal to k−1, the control goes to step 221. When is equal to k−1, the half adder allocatable position search unit 104 allocates half adders to all the positions where the half adders can be used, except for the digits where no carry exists in the corresponding stage of the operation block (refer to step 220). In step 221, the operation block corresponding stage construction unit 108 constructs the first-stage operation block on the basis of the above-mentioned allocation.

Next, in steps 222 to 225, the same processings as those performed in steps 208 to 211 in the first pass are carried out.

Thereafter, the second and subsequent stages are constituted and constructed in like manner as mentioned above. When it is judged in step 224 that there exists no position having three or more inputs, the final-stage construction unit 112 constructs the final-stage operation block as shown in FIG. 11 by the CLA method (refer to step 226). All the stages of operation blocks thus constituted and constructed are outputted from the output unit 113 to be displayed or printed by a monitor MN or a printer, respectively, or outputted to the outside through a network or the like.

As described above, according to the second embodiment of the present invention, in the automatic circuit synthesis device for synthesizing a multi-input adder comprising plural stages of operation blocks, full adders are allocated to all positions where the full adders can be used in the respective operation blocks, thereby to automatically derive as to what number stage the final stage corresponds to. Thereafter, when constituting the plural stages of operation blocks again, the respective operation blocks are constructed by automatically applying the rules of the above-mentioned i) to iii), i.e., the rules including using full adders in all the positions where full adders can be used in each operation block, using a half adder at only the least significant bit side in each operation block, using a half adder in a position having five inputs at a digit that is one digit higher than a digit having two carries of a full adder in the operation block three stages prior to the final operation block, and using a half adder at a digit having a carry from the lower bit in the operation block one block prior to the final operation block. Therefore, it is possible to automatically synthesize a multiplier having a multi-input adder which can achieve simultaneous pursuit of reduction in operation time and reduction in circuit scale, without performing a manual work which is complicated, requires long time, and easily causes errors.

While in this second embodiment an automatic circuit synthesis device for automatically synthesizing a multi-input adder is described, a method identical to the synthesis method executed by this device may be provided, or a program in which this method is described or a medium in which this program is recorded may be provided.

Further, while in this second embodiment a method of constructing the operation blocks shown in FIG. 8(a) is adopted to detect as to what number stage the final stage corresponds to, another method may be adopted.

### APPLICABILITY IN INDUSTRY

As described above, a multi-input adder, a synthesis device thereof, a synthesis method, a synthesis program, and a synthesis program storage medium according to the present invention can realize a compact and high-speed multi-input adder by restricting positions where half adders and full adders are used, and thus obtained adder is useful as a multi-input adder in a multiplier or a FIR filter. Further, the multi-input adder can be utilized in an optical recording information device or a communication device, or as a fundamental operation device for various digital signal processings.

1. An adder having plural stages of operation blocks, each operation block including at least either of half adders and full adders, and having inputs of plural digits, wherein in an operation block which is three stages prior to a final-stage operation block, a half adder is provided at a digit which is located by one digit upper than a digit having two carries of a full adder, and has five inputs, and
in an operation block which is four stages prior to the final-stage operation block, a half adder is provided at a digit which is located by one digit upper than a digit having three carries of a full adder, and has eight inputs.

2. An adder as defined in claim 1 wherein the inputs of plural digits are signed integers or signed decimals.

3. An adder as defined in claim 1 wherein the inputs of plural digits are outputs of a partial product operation circuit which calculates partial products of inputs of multipliers.

4. An adder as defined in claim 3 wherein the inputs of the multipliers are signed integers or signed decimals.

5. An adder as defined in claim 1 wherein the inputs of plural digits are outputs of a partial product operation circuit which calculates partial products of multipliers disposed in an input stage of an FIR (Finite Impulse Response) filter.

6. An adder as defined in claim 5 wherein the inputs of the FIR filter are signed integers or signed decimals.

7. An adder as defined in claim 5 wherein the FIR filter has signed integers or signed decimals as factors.

8. An adder as defined in claim 1 wherein, in each stage of the operation block, a half adder is provided at a digit which is positioned at the least significant side and has inputs the number of which is not one, and has two inputs.

9. An adder as defined in claim 8 wherein a half adder is provided in an operation block which is one stage prior to a final-stage operation block.

10. An adder as defined in claim 9 wherein, in an operation block which is one stage prior to a final-stage operation block, a half adder is provided at a digit which is lower than a digit that is positioned at the most significant side and has inputs the number of which is one.

11. A synthesis device for an adder having plural stages of operation blocks, each operation block including at least either of half adders and full adders, and having inputs of plural digits, wherein
in an operation block which is three stages prior to a final-stage operation block, a half adder is allocated to a digit which is located by one digit upper than a digit having two carries of a full adder, and has five inputs, and
in an operation block which is four stages prior to the final-stage operation block, a half adder is allocated to a digit which is located by one digit upper than a digit having three carries of a full adder, and has eight digits.

12. A synthesis device for an adder as defined in claim 11 wherein, in each stage of the operation block, a half adder is allocated to a digit which is located at the least significant side and has inputs the number of which is not one, and has two inputs.

13. A synthesis device for an adder as defined in claim 12 wherein a half adder is allocated to an operation block which is one stage prior to a final-stage operation block.

14. A synthesis device for an adder as defined in claim 13 wherein, in an operation block that is one stage prior to a final-stage operation block, a half adder is allocated to a digit which is lower than a digit that is positioned at the most significant side and has inputs the number of which is one.

15. A synthesis method for an adder having plural stages of operation blocks, each operation block including at least either of half adders and full adders, and having inputs of plural digits, said method including:
a process of allocating a half adder to a digit which is located by one digit upper than a digit having two carries of a full adder, and has five inputs, in an operation block which is three stages prior to a final-stage operation block and
allocating a half adder to a digit which is located by one digit upper than a digit having three carries of a full adder, and has eight inputs, in an operation block which is four stages prior to the final-stage operation block.

16. An adder synthesis program which makes a computer perform the adder synthesis method defined in claim 15.

17. An adder synthesis program storage medium in which the adder synthesis program defined in claim 16 is stored.
